(19) United States
(12) Patent Application Publication
(10) Pub. No.: US 2025/0392126 A1
(43) Pub. Date: Dec. 25, 2025

(54) ESSENTIAL AND CURTAILABLE LOAD DISTRIBUTION OPTIMIZATION IN MICROGRID CONTROLLER

(71) Applicant: Caterpillar Inc., Peoria, IL (US)

(72) Inventors: Sowmya NAGESH, Peoria, IL (US); Gregory Scott HASLER, Pekin, IL (US); Ronald Christopher GAYLES, Peoria, IL (US); Matthew L. ANDREWS, Woodstock, GA (US); Thorsten MAYER, Nierstein (DE)

(73) Assignee: Caterpillar Inc., Peoria, IL (US)

(21) Appl. No.: 18/749,018

(22) Filed: Jun. 20, 2024

(51) Int. Cl. H02J 3/00; G05B 15/02

(52) U.S. Cl. CPC H02J 3/0075; G05B 15/02

(57) ABSTRACT

A method implemented by a microgrid controller includes dynamically assigning a priority level in a tiered priority scheme to each load of a plurality of loads based on load information; monitoring an available power limit of a microgrid; comparing a load demand of the plurality of loads with the available power limit to generate a comparison result; and dynamically adding and shedding connections of the plurality of loads to a power distribution network of the microgrid based on the priority level of each load and based on the comparison result, including generating one or more first control signals to connect a first group of loads having highest rankings in priority level to the power distribution network of the microgrid, and generating one or more second control signals to disconnect a second group of loads having lowest rankings in priority level from the power distribution network of the microgrid.

### TECHNICAL FIELD

The present disclosure relates generally to microgrids and, for example, to a microgrid controller configured to control or manage an operation of a microgrid.

### BACKGROUND

A microgrid is a self-sufficient energy system that serves a particular geographic area, such as a college campus, a hospital complex, a business center, a neighborhood, a mining site, a drilling site, and/or the like. Within a microgrid are one or more kinds of distributed energy resources (DERs) (e.g., solar panels, wind turbines, fuel cells, photovoltaic (PV) cells, generators, energy storage devices (e.g., batteries, capacitors, etc.), and/or other energy sources) that produce power for the microgrid. Some microgrids are configured as off-grid electrical power distribution systems (e.g., stand-alone microgrids or islands) that do not connect to a larger electrical power distribution system (e.g., a macrogrid) run by, for example, an electric utility or power plant. Some microgrids are able to operate in a grid-connected mode and in a stand-alone mode. In a grid-connected mode, a microgrid may operate connected to and synchronous with the larger electrical power distribution system. In a stand-alone mode, the microgrid may be disconnected from the larger electrical power distribution system and operate as a stand-alone microgrid. A microgrid controller may control whether the microgrid operates in the grid-connected mode or in the stand-alone mode, for example, based on a schedule or based on one or more conditions being satisfied.

In a power distribution system, there may be essential and non-essential loads based on different applications. Thus, different tiers of loads may exist. However, the power distribution system, such as a microgrid, may not be capable of simultaneously accommodating all loads based on an available power limit of the power distribution system. The available power limit may depend on a number of DERs and/or type of DERs available to deliver power to the power distribution system.

U.S. Pat. No. 5,543,667 (“the '667 patent”) discloses an add/shed load controller which will add/shed or increase/decrease the electrical usage of a load. In the '667 patent, a maximum decrease limit may be set for analog loads to insure that comfort is not overly affected due to load usage reductions. The '667 patent discloses that the most common type of add/shed control system establishes a prioritized load order wherein the load having lowest priority will be shed first and the load having highest priority will be shed last. Further, the '667 patent describes that the processor includes a floating demand limit section, which may be utilized to increase energy savings, and explains that as power consumption approaches the floating demand limit, the loads assigned to the first nine shed orders can be shed to maintain power consumption below the floating demand limit. However, the '667 patent does not provide a combined approach to dynamically load shed, load add, and load curtail as the available power limit changes and/or as loads are dynamically connected to or disconnected from the power distribution system.

The microgrid controller of the present disclosure solves one or more of the problems set forth above and/or other problems in the art. For example, the microgrid controller may execute a load shed/load add (LSLA) algorithm to control one or more loads associated with a microgrid according to a dynamic priority scheme in order to satisfy an available power limit of the microgrid. The dynamic priority scheme includes adding, shedding, and/or curtailing loads from the microgrid based on different applications.

### SUMMARY

In some implementations, a microgrid controller of a microgrid includes one or more memories configured to store an LSLA algorithm; a communication interface configured to receive load information corresponding to a plurality of loads and output one or more control signals for controlling connections of the plurality of loads to the microgrid; and one or more processors, coupled to the one or more memories, configured to execute the LSLA algorithm to generate the one or more control signals based on the load information, wherein executing the LSLA algorithm comprises: dynamically assigning a priority level in a tiered priority scheme to each load of the plurality of loads based on the load information, monitoring an available power limit of the microgrid, comparing a load demand of the plurality of loads with the available power limit of the microgrid to generate a comparison result, and dynamically adding and shedding the connections of the plurality of loads to a power distribution network of the microgrid based on the priority level of each load and based on the comparison result, including generating one or more first control signals to connect a first group of loads having highest rankings in priority level to the power distribution network of the microgrid, and generating one or more second control signals to disconnect a second group of loads having lowest rankings in priority level from the power distribution network of the microgrid.

In some implementations, a microgrid controller of a microgrid includes one or more memories configured to store a curtailable load algorithm; a communication interface configured to receive load information corresponding to a plurality of curtailable loads connected to a microgrid, and output one or more control signals for regulating a power allocation to each of the plurality of curtailable loads; and one or more processors, coupled to the one or more memories, configured to execute the curtailable load algorithm to generate the one or more control signals based on the load information, wherein executing the curtailable load algorithm comprises: dynamically assigning a priority level in a tiered priority scheme to each curtailable load of the plurality of curtailable loads based on the load information, monitoring an available power limit of the microgrid, comparing a load demand of the plurality of curtailable loads with the available power limit of the microgrid to generate a comparison result, and dynamically regulating the power allocation of the plurality of curtailable loads based on the priority level of each curtailable load and based on the comparison result, including generating one or more first control signals to allocate one or more prioritized power levels to a first group of curtailable loads having highest rankings in priority level among the plurality of curtailable loads, and generating one or more second control signals to allocate one or more reduced power levels to a second group of curtailable loads having lower rankings in priority level among the plurality of curtailable loads.

In some implementations, a method includes receiving, by a microgrid controller, load information corresponding to a plurality of loads associated with a microgrid; dynamically assigning, by the microgrid controller, a priority level in a tiered priority scheme to each load of the plurality of loads based on the load information; monitoring, by the microgrid controller, an available power limit of the microgrid; comparing, by the microgrid controller, a load demand of the plurality of loads with the available power limit of the microgrid to generate a comparison result; and dynamically adding and shedding, by the microgrid controller, connections of the plurality of loads to a power distribution network of the microgrid based on the priority level of each load and based on the comparison result, including generating one or more first control signals to connect a first group of loads having highest rankings in priority level to the power distribution network of the microgrid, and generating one or more second control signals to disconnect a second group of loads having lowest rankings in priority level from the power distribution network of the microgrid.

In some implementations, a method includes receiving, by a microgrid controller, load information corresponding to a plurality of curtailable loads associated with a microgrid; dynamically assigning, by the microgrid controller, a priority level in a tiered priority scheme to each curtailable load of the plurality of curtailable loads based on the load information; monitoring, by the microgrid controller, an available power limit of the microgrid; comparing, by the microgrid controller, a load demand of the plurality of curtailable loads with the available power limit of the microgrid to generate a comparison result; and dynamically regulating, by the microgrid controller, a power allocation of the plurality of curtailable loads based on the priority level of each curtailable load and based on the comparison result, including generating one or more first control signals to allocate one or more prioritized power levels to a first group of curtailable loads having highest rankings in priority level among the plurality of curtailable loads, and generating one or more second control signals to allocate one or more reduced power levels to a second group of curtailable loads having lower rankings in priority level among the plurality of curtailable loads.

### BRIEF DESCRIPTION OF THE DRAWINGS

FIG. 1 shows a system according to one or more implementations.

FIG. 2 shows a microgrid according to one or more implementations.

FIG. 3 shows a microgrid according to one or more implementations.

FIG. 4 is a flowchart of an example process associated with essential and curtailable load distribution optimization in a microgrid controller.

FIG. 5 is a flowchart of an example process associated with essential and curtailable load distribution optimization in microgrid controller.

FIG. 6 is a diagram of example components of the microgrid controller associated with improved peak microgrid load dispatch.

### DETAILED DESCRIPTION

This disclosure relates to a power distribution system, which is applicable to any system that distributes and/or receives power via a power grid. Some aspects relate to a microgrid controller that is configured to control one or more components and/or systems associated with the microgrid, including energy resource systems and/or loads. The microgrid controller may control a state of the microgrid based on one or more conditions being satisfied.

The microgrid controller executes program code (e.g., instructions) of an LSLA algorithm and/or a curtailable load algorithm to add, shed, and/or curtail loads based on different applications and based on a priority level of each load. The microgrid controller may prioritize essential loads over non-essential loads and/or prioritize a charging load (chargeable load) or a bidirectional load as a curtailable load. The microgrid controller may open and close distribution breakers to be able to shed loads from or add loads to a power distribution network of the microgrid and operate in tandem with curtailing charging loads. Curtailing a curtailable load reduces or otherwise limits a rate of charge (e.g., a supply of charging power) provided to the curtailable load relative to maximum rate of charge of the curtailable load. The microgrid controller may add a certain number of essential loads to the power distribution network, and may deem all remaining loads non-essential. In some cases, the microgrid controller may shed a certain number of non-essential loads from the power distribution network, and curtail other non-essential loads (e.g., non-essential curtailable loads). In some cases, the microgrid controller may shed all non-essential loads from the power distribution network. As a result, the microgrid controller may efficiently manage different types of loads in order to prioritize different load demands while meeting an available power limit of the microgrid.

A load shed/load add function and a curtailable load management function can operate in tandem or separately from each other. Some microgrids may not require charging loads such that the curtailable load management function may be disabled. The microgrid controller may function as an energy management system (EMS), especially when no other EMS exists at a location of the microgrid (e.g., mining sites). In addition, the microgrid controller may operate in tandem with an autonomous fleet management system to make the curtailable load management function completely seamless with fleet autonomy.

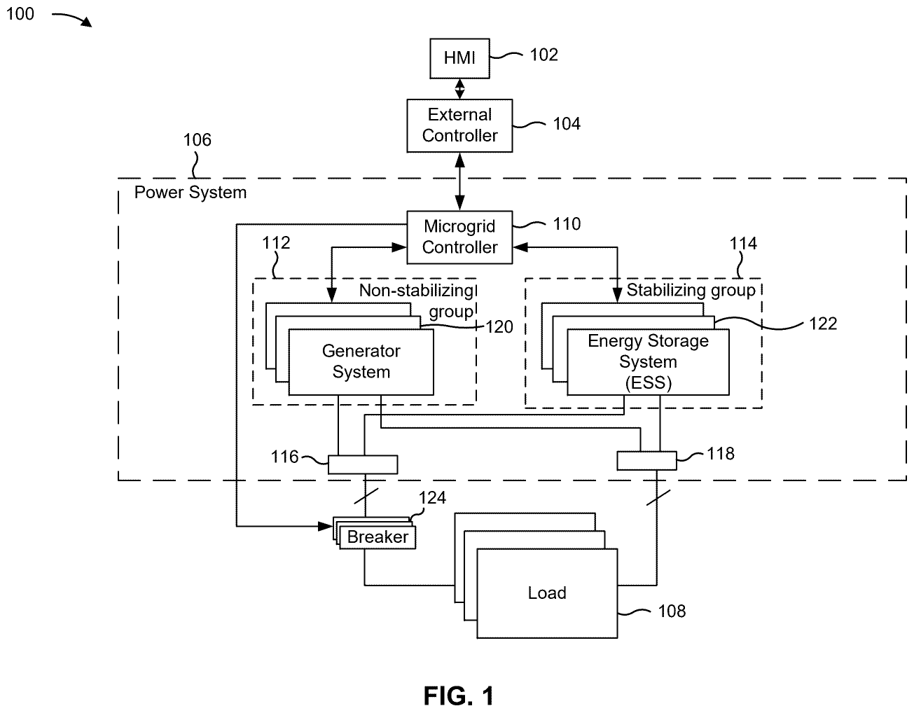

FIG. 1 shows a system 100 according to one or more implementations. The system 100 may include a human-to-machine interface (HMI) 102, an external controller 104, a power system 106, and one or more loads 108.

The power system 106 may be a microgrid or other type of electrical power distribution system that may provide power to the one or more loads 108. In some cases, the power system 106 may be an off-grid electrical power distribution system. In some cases, the power system 106 may be configurable to operate in a grid-connected mode and in a stand-alone mode. The power system 106 may include a microgrid controller 110, a non-stabilizing group of energy resource systems 112 (e.g., a non-stabilizing group of DERs), a stabilizing group of energy resource systems 114 (e.g., a stabilizing group of DERs), and interfaces 116 and 118. Generally, “off-grid” may mean that the electrical power distribution system is not connected to a larger electrical power distribution system run by, for example, an electric utility or other large-scale electric power generation plant that serves electricity to a geographic area, campus, compound, etc. However, techniques disclosed herein may still be applied to electrical power distribution systems that are connected to larger electrical power distribution systems. For instance, the larger electrical power distribution systems may operate as a power source in a primary provider role or secondary provider role, while the power system 106 may operate as a power source in the other of the primary provider role or secondary provider role.

The non-stabilizing group of energy resource systems 112 may include one or more energy generator systems 120. Each energy generator system 120 may include a power generator (e.g., an engine-generator, a fuel cell, a PV cell, or other power generating system) and a local generator controller communicatively coupled to the microgrid controller 110. Thus, each energy generator system 120 may generate power from a respective power source. Each local generator controller may control how much power a respective power generator generates, control a rate of power distribution, and/or obtain status information corresponding to the respective power generator. Each local generator controller may be controlled by the microgrid controller 110.

The stabilizing group of energy resource systems 114 may include one or more energy storage systems (ESSs) 122. Each energy storage system 122 may include an electric storage device (e.g., one or more batteries and/or capacitors) and a local ESS controller communicatively coupled to the microgrid controller 110. Each local ESS controller may control a flow of power into or out of a respective electric storage device, including charging of the respective electric storage device and discharging of the respective electric storage device, control a rate of power flow, and/or obtain status information corresponding to the respective electric storage device, such as state-of-charge (SOC), state-of-health (SOH), discharge limit, and other device parameters. Each local ESS controller may be controlled by the microgrid controller 110.

The system 100 may also include one or more breakers 124 (e.g., distribution breakers or switches) that may be individually controlled by the microgrid controller 110 to connect a respective load 108 to the power system 106 or disconnect the respective load 108 from the power system 106 (for example, according to an LSLA algorithm). The one or more breakers 124 may be part of one or both interfaces 116 and 118. Additionally, or alternatively, the microgrid controller 110 may curtail one or more curtailable loads (e.g., charging loads) that are connected to the power system 106, for example, according to a curtailable load algorithm.

The HMI 102 may include one or more processors, and may be configured to receive and process one or more inputs from a user, such as an operator. Additionally, the HMI 102 may be configured to provide one or more prompts or outputs to the user. Thus, the HMI 102 may be a user terminal configured to interact with a user to process information and/or commands provided by the user, provide information to the user (e.g., status information), and/or perform one or more tasks or functions in response to processing the information and/or commands provided by the user. The HMI 102 may be communicatively coupled to the external controller 104, which may be communicatively coupled to the microgrid controller 110. In some implementations, the HMI 102 may be communicatively coupled directly to the microgrid controller 110. The external controller 104 may send commands to and receive information from the microgrid controller 110. For example, the external controller 104 may send commands to the microgrid controller 110 based on information received from the HMI 102. Thus, the external controller 104 may be a user-commanded controller. The external controller 104 may be integrated with the HMI 102. The external controller 104 may be a controller of a larger electrical power distribution system (e.g., a macrogrid, a power generation plant, and/or electric utility provider).

The power system 106 may provide electrical power to the one or more loads 108. Generally, the power system 106 may provide alternating current (AC) power at a particular voltage and a particular current. The microgrid controller 110 may control one or more energy storage systems 122 to instantaneously inject power when power is needed by the power system 106 or instantaneously absorb surplus power generated by the power system 106. Accordingly, one of more electric storage devices of the energy storage systems 122 may act as a power consumer on one or more energy generator systems 120 or as a power source for the one or more energy generator systems 120, to thereby ensure that system bus frequencies of the non-stabilizing group of energy resource systems 112 are maintained at a nominal value. In other words, the microgrid controller 110 may control the stabilizing group of energy resource systems 114 to stabilize loads of the non-stabilizing group of energy resource systems 112 in order to maintain the non-stabilizing group of energy resource systems 112 at a relatively constant load, which may reduce a recurrence of frequency deviations from the nominal value.

The microgrid controller 110 may be integrated with, or separate from (but connected to), the interfaces 116 and 118, the energy generator systems 120, and the energy storage systems 122, or combinations thereof. In this manner, a user may, through interaction with the HMI 102, add or remove energy generator systems 120 to increase/reduce system power generation and/or add or remove energy storage systems 122 to increase/reduce system energy storage capacity, in accordance with a user's preference. For instance, a user may prefer to add additional energy generator systems 120 and/or add additional energy storage systems 122 to increase load capacity if additional loads 108 are expected to be connected to the power system 106, or remove energy generator systems 120 and/or remove energy storage systems 122 to decrease load capacity if loads 108 are expected to be disconnected from the power system 106. Additionally, the microgrid controller 110 may be configured to add or remove energy generator systems 120 and/or add or remove energy storage systems 122 from the power system 106 based one or more conditions being satisfied. In some cases, the microgrid controller 110 may be configured to add or remove energy generator systems 120 and/or add or remove energy storage systems 122 from the power system 106 based on a schedule.

The one or more loads 108 may be any device that can connect to a power distribution system, such as the power system 106, to receive electrical power. Examples of loads may include heavy machinery (e.g., electric mining machines, haulers, etc.), personal devices, appliances, heating, ventilation, and air conditioning (HVAC) systems, industrial drills, personal residence electrical distribution systems, etc. The loads 108 may include one or more non-stable loads, such as one or more cyclic loads. The loads 108 may include unidirectional loads (e.g., loads that can only receive power from the power system 106), bi-directional loads (e.g., loads that can both receive power from the power system 106 and provide power to the power system 106), charging loads (e.g., loads that include a chargeable electric battery), essential loads (e.g., loads that require uninterrupted service), and/or non-essential loads (e.g., loads that do not require uninterrupted service). Loads may be assigned different priorities based on load type, load classification, and/or operation state or mode.

Generally, the one or more loads 108 may receive the power from the power system 106 and use the power in accordance with the operations of the one or more loads 108. Users of the power system 106 and the one or more loads 108 may connect/disconnect the one or more loads 108 by electrically connecting the one or more loads 108 to the interfaces 116 and 118 of the power system 106. For instance, the interfaces 116 and 118 may have AC plugs/sockets to connect the one or more loads 108 in parallel to the one or more energy generator systems 120 and the one or more energy storage systems 122 of the power system 106. One or more loads 108 may include a local load controller that may collect load information and transmit the load information to the microgrid controller 110. Load information may include information indicating a load type, a load classification, and/or an operation state or mode of a load 108 (e.g., charging state, moving state, etc.). Load information may include load data of a load, such as maximum load and minimum load. For chargeable loads, load information may include maximum charging load, maximum state of charge, minimum state of charge, current state of charge, and usable discharge energy as a function of the current state of charge. Load information may be received by the microgrid controller 110 via the interfaces 116 and 118, which may include one or more communication interfaces coupled to the microgrid controller 110.

The interfaces 116 and 118 may also have a plurality of generator connections and a plurality of energy store connections. The plurality of generator connections may be hardwired electrical connections and/or AC plugs/sockets to connect the one or more energy generator systems 120 in parallel to the at least one load 108 and the one or more energy storage systems 122. The plurality of energy store connections may be hardwired electrical connections and/or AC plugs/sockets to connect the one or more energy storage systems 122 in parallel to the one or more loads 108 and the one or more energy generator systems 120. For instance, the power system 106 may or may not allow addition/removal of energy generator systems 120 and/or addition/removal of energy storage systems 122. Therefore, depending on a configuration, the interfaces 116 and 118 may include: (1) hardwired electrical connections that connect the at least one energy generator system 120; (2) AC plugs/sockets to connect/disconnect the at least one energy generator system 120; (3) hardwired electrical connections that connect the at least one energy storage system 122; and/or (4) AC plugs/sockets to connect/disconnect the at least one energy storage system 122. The interfaces 116 and 118 may be coupled to a system bus (e.g., a power bus) of the power system 106. The system bus may enable one of more of the energy storage systems 122 to absorb power from one or more energy generator systems 120 and/or one or more loads 108 (e.g., for charging and/or storing power).

The one or more energy generator systems 120 may also include communication interfaces. The communication interfaces of the one or more energy generator systems 120 may enable the one or more energy generator systems 120 to communicate with the microgrid controller 110. For instance, the one or more energy generator systems 120 may be connected to the microgrid controller 110 by wired or wireless communication. The one or more energy generator systems 120 may provide the microgrid controller 110 with generator data. The generator data, for each of the one or more energy generator systems 120, may include load data and/or generator parameters. The load data may include a current (e.g., instantaneous) load seen by the one or more energy generator systems 120 and/or past load data (if one or more energy generator systems 120 store such data locally). The current load/past load data may include voltage (e.g., in volts) and/or current (e.g., in amperes) measured by one or more sensor components included in an energy generator system 120. The generator parameters may include a generator set maximum threshold value and a generator set minimum threshold value. Alternatively, to reduce transmission bandwidth, the generator data may omit the generator parameters, and the one or more energy generator systems 120 may transmit the generator parameters during an initial configuration process between the one or more energy generator systems 120 and the microgrid controller 110. The generator set maximum threshold value and the generator set minimum threshold value may indicate a maximum power load and a minimum power load, respectively, that a generator of an energy generator system 120 may support.

The one or more energy storage systems 122 may be any energy storage device that can store and output AC power. For instance, the one or more energy storage systems 122 may include at least one electrical-chemical energy storage (e.g., a battery), electrical energy storage (e.g., a capacitor, a supercapacitor, or a superconducting magnetic energy storage), mechanical energy storage (e.g., a fly wheel, a pump system), and/or any combination thereof. The one or more energy storage systems 122 may include inverters (individually or collectively) so that the one or more energy storage systems 122 may operate as a power consumer or a power source. The one or more energy storage systems 122 may also include electronic control mechanisms to control (1) how much load the one or more energy storage systems 122 draw, or (2) how much AC power the one or more energy storage systems 122 output.

The one or more energy storage systems 122 may also include communication interfaces. The communication interfaces of the one or more energy generator systems 120 may enable the one or more energy storage systems 122 to communicate with the microgrid controller 110. For instance, the one or more energy storage systems 122 may be connected to the microgrid controller 110 by wired or wireless communication. The one or more energy storage systems 122 may provide the microgrid controller 110 with energy storage data and may receive instructions from the microgrid controller 110.

The energy storage data may include, for each of the at least one energy store, a current energy level (e.g., kilowatt-hours currently stored), total energy storage capacity (e.g., kilowatt-hours of capacity), and/or discharge/charge parameters. The current energy level may be measured by a battery meter of an energy storage. The battery meter may one or combinations of a voltmeter, an amp-hour meter, and/or an impedance-based meter. The discharge/charge parameters may indicate an amount of discharge power and an amount of charge power for a respective energy storage device of the one or more energy storage systems 122. Alternatively, to reduce transmission bandwidth, the energy storage data may omit the discharge/charge parameters, and the one or more energy storage systems 122 may transmit the discharge/charge parameters when the one or more energy storage systems 122 are first connected to the microgrid controller 110.

The one or more energy storage systems 122 may receive requests (e.g., instructions) for the energy storage data to provide the energy storage data and/or continuously provide the energy storage data to the microgrid controller 110. The instructions may include energy storage dispatch (ESD) instructions. An ESD instruction may include an instruction to inject power to a system bus of the power system 106 or absorb power from the system bus of the power system 106. ESD instructions may be provided in control signals (e.g., communication signals that provide the ESD instructions). At least one ESD instruction may be utilized to rapidly stabilize the load, thereby stabilizing the bus frequency of the power system 106 in a time efficient manner, rather than attempting to stabilize the load using the one or more energy generator systems 120 alone. The one or more energy storage systems 122 may control the inverters and the electronic control mechanisms to control (1) quantity of load drawn by the one or more energy storage systems 122, or (2) the amount of AC power output produced by the one or more energy storage systems 122, in accordance with the ESD instructions.

The microgrid controller 110 may include at least one memory device (e.g., one or more memories) for storing instructions (e.g., program code); at least one processor for executing the instructions from the memory device to perform a set of desired operations; and a communication interface (e.g., coupled to a communication bus) for facilitating the communication between various system components. The instructions may be computer-readable instructions for executing a control application. The communication interface of the microgrid controller 110 may enable the microgrid controller 110 to communicate with the one or more energy generator systems 120 and the one or more energy storage systems 122. The microgrid controller 110, while executing the control application, may receive the generator data and the energy storage data (e.g., energy resource information), process the generator data and the energy storage data to generate one or more ESD instructions, and output the ESD instructions to one or more energy generator systems 120 and/or to one or more energy storage systems 122, so that the one or more energy generator systems 120 are protected from transient changes in load.

The instructions may include an LSLA algorithm and/or a curtailable load algorithm that may be executed by the microgrid controller 110 to dynamically manage the loads 108. In some cases, the curtailable load algorithm may be incorporated into the LSLA algorithm. The communication interface of the microgrid controller 110 may receive load information corresponding to the plurality of loads 108 and output one or more control signals for controlling connections of the plurality of loads to the microgrid and/or a charging rate of one or more curtailable loads. The one or more curtailable loads may be charging loads configured with respective chargeable batteries. For example, an electric vehicle with a chargeable battery may be a one type of curtailable load. The one or more control signals may control one or more breakers 124 (e.g., a plurality of distribution breakers) of the power distribution network to add and/or shed one or more loads 108. For example, the microgrid controller 110 may control open and closed states of the breakers 124 in order to control the connections of the plurality of loads to the power distribution network of the microgrid. Additionally, or alternatively, one or more control signals may be sent to interface 116 or interface 118 to control a charging rate of the one or more loads 108 (e.g., one or more curtailable loads of the plurality of loads 108).

One or more processors of the microgrid controller 110 may execute the LSLA algorithm and/or the curtailable load algorithm to generate the one or more control signals based on the load information.

Executing the LSLA algorithm may include dynamically assigning a priority level in a tiered priority scheme to each load of the plurality of loads 108 based on the load information, monitoring an available power limit of the microgrid, comparing a load demand of the plurality of loads 108 with the available power limit of the microgrid to generate a comparison result, and dynamically adding and shedding the connections of the plurality of loads 108 to a power distribution network (e.g., a power bus network) of the microgrid based on the priority level of each load and based on the comparison result. Dynamically adding and shedding the connections of the plurality of loads 108 to the power distribution network may include generating one or more first control signals to connect a first group of loads having highest rankings in priority level to the power distribution network of the microgrid, and generating one or more second control signals to disconnect a second group of loads having lowest rankings in priority level from the power distribution network of the microgrid. The microgrid controller 110 may manage which loads 108 are included in the first group of loads such that a total load of the first group of loads does not exceed the available power limit of the microgrid.

The tiered priority scheme may be a numeric-based prioritization scheme with the priority level of each load being assigned a different number. Thus, each load 108 has a priority level that is distinguishable from the other loads 108. The load information may indicate a load type of each load, and the microgrid controller 110 may assign the priority level to each load of the plurality of loads 108 based on the load type of each load. The load information may indicate an operating state of each load, and the microgrid controller 110 may assign the priority level to each load of the plurality of loads 108 based on the operating state of each load.

The first group of loads may include a fixed number of essential loads and a variable number of non-essential loads. The variable number of non-essential loads may depend on the available power limit of the microgrid. As a result, the fixed number of essential loads may always be connected to the power distribution network of the microgrid. However, a number of non-essential loads that are connected to the power distribution network of the microgrid may depend on the available power limit of the microgrid and the load information provided by the non-essential loads (e.g., how much power each load draws).

The load information may include an availability of each load to receive power from the microgrid. For example, the availability of a load may refer to whether the load is connected to one of the interfaces 116 or 118, capable of receiving power from the macrogrid, and/or whether the load is online or offline. The microgrid controller 110 may, based on the load information, identify which loads of the plurality of loads 108 are available to receive power from the microgrid as an availability of each load changes, and dynamically assign the priority level to each load of the plurality of loads 108 based on which loads of the plurality of loads are available to receive power from the microgrid. Thus, the microgrid controller 110 may change the priority levels of one or more loads based on a load being made available to receive power from the microgrid and based on the load being made unavailable to receive power from the microgrid.

For example, when a new load is introduced for possible connection to the power distribution network, the microgrid controller 110 assigns a priority level to the new load, which may bump one or more loads to a lower priority. As a result, some essential loads may be bumped down to non-essential type loads (e.g., if the new load has a higher priority than the essential loads), and/or some non-essential loads that are connected to the power distribution network may be bumped down to a disconnected status and shed from the power distribution network. Conversely, when an existing load is removed or taken offline, some non-essential loads may be bumped up to essential type loads (e.g., if the removed load has a higher priority than the non-essential loads), and/or some non-essential loads that are disconnected from the power distribution network may remain non-essential loads, but may be bumped up to a connected status and added to the power distribution network. Thus, the microgrid controller 110 may change the priority level of one or more loads based on a change in the load information, for example, when one or more loads are made available to the power distribution network, one or more loads are made unavailable to the power distribution network, and/or when a required operating power of one or more loads changes.

In some cases, the first group of loads are all essential loads, and the second group of loads are all non-essential loads. Thus, all non-essential loads may be shed from the power distribution network, while all essential loads may be connected to the power distribution network. In addition, the microgrid controller 110 may assign a static top priority to an essential load of the plurality of loads 108. For example, the essential load having the static top priority may be a critical load, such as a medical center, that requires continuous power.

In some cases, a first number of loads in the first group of loads and a second number of loads in the second group of loads change based on a change in the available power limit of the microgrid. For example, the first number of loads may increase as the available power limit increases and may decrease as the available power limit decreases. Thus, the microgrid controller 110 may add one or more loads to the first group as the first number increases, and may shed one or more loads from the first group as the first number increases.

The load information may include an availability of each load to receive power from the microgrid. For example, the availability of a load may refer to whether the load is connected to one of the interfaces 116 or 118, capable of receiving power from the macrogrid, and/or whether the load is online or offline. The microgrid controller 110 may, based on the load information, identify which loads of the plurality of loads 108 are available to receive power from the microgrid as an availability of each load changes, and dynamically assign the priority level to each load of the plurality of loads 108 based on which loads of the plurality of loads are available to receive power from the microgrid. Thus, the microgrid controller 110 may change the priority levels of one or more loads based on a load being made available to receive power from the microgrid and/or based on a load being made unavailable to receive power from the microgrid.

As disclosed above, the plurality of loads 108 may include one or more curtailable loads. Executing the curtailable load algorithm may include assigning a priority level in the tiered priority scheme to each curtailable load based on an operating mode of each curtailable load. The load information received by the microgrid controller 110 may indicate the operating mode of each curtailable load. The operating mode may include, for example, whether the curtailable load is in a charging mode or a discharging mode. For an electric vehicle, the operating mode may include whether the electric vehicle is stationary or non-stationary. The microgrid controller 110 may increase the priority level of a curtailable load based on the curtailable load operating in a first operating mode, and decrease the priority level of the curtailable load based on the curtailable load operating in a second operating mode. For example, the microgrid controller 110 may prioritize a first curtailable load operating in a non-stationary mode over a second curtailable load operating in a stationary mode. Thus, a moving electric vehicle that is connected to the microgrid may be prioritized over a non-moving electric vehicle that is connected to the microgrid. The microgrid controller 110 may assign each curtailable load in the first group of loads to a first priority sub-group or a second priority sub-group based on the operating mode of each curtailable load in the first group of loads. Additionally, the microgrid controller 110 may allocate a maximum power level to each curtailable load assigned to the first priority sub-group, and allocate a reduced (curtailed) power level to each curtailable load assigned to the second priority sub-group. For example, curtailable loads operating in the non-stationary mode may be allocated to the first priority sub-group, and curtailable loads operating in the stationary mode may be allocated to the second priority sub-group. Thus, the curtailable load algorithm may be part of the LSLA algorithm or may be executed in parallel with the LSLA algorithm.

Executing the curtailable load algorithm may include curtailing one or more curtailable loads based on priority level. For example, the communication interface of the microgrid controller 110 may receive load information corresponding to a plurality of curtailable loads connected to the microgrid, and output one or more control signals for regulating a power allocation to each of the plurality of curtailable loads. The microgrid controller 110 may dynamically assign a priority level in a tiered priority scheme to each curtailable load of the plurality of curtailable loads based on the load information, monitor the available power limit of the microgrid, compare a load demand of the plurality of curtailable loads with the available power limit of the microgrid to generate a comparison result, and dynamically regulate the power allocation of the plurality of curtailable loads based on the priority level of each curtailable load and based on the comparison result. The microgrid controller 110 may generate one or more first control signals to allocate one or more prioritized power levels to a first group of curtailable loads having highest rankings in priority level among the plurality of curtailable loads, and generate one or more second control signals to allocate one or more reduced power levels to a second group of curtailable loads having lower rankings in priority level among the plurality of curtailable loads. In some cases, the microgrid controller 110 may generate one or more third control signals to allocate a zero power level to a third group of curtailable loads having lowest rankings in priority level among the plurality of curtailable loads.

The priority levels may be assigned based on a type of curtailable load, an SOC of each curtailable load, and/or an operating mode of each curtailable load. For example, curtailable loads operating in the non-stationary mode may be allocated to the first group of curtailable loads. In addition, curtailable loads operating in the stationary mode may be allocated, based on priority level, to the second group of curtailable loads or the third group of curtailable loads. In other words, curtailable loads operating in the non-stationary mode may be classified as essential loads and curtailable loads operating in the stationary mode may be classified as non-essential loads. A number of curtailable loads assigned to the second group of curtailable loads may depend on a remaining available power limit of the microgrid after the first group of curtailable loads are allocated to the microgrid. The third group of curtailable loads may include those curtailable loads that remain after the second group of curtailable loads take up the remaining available power limit.

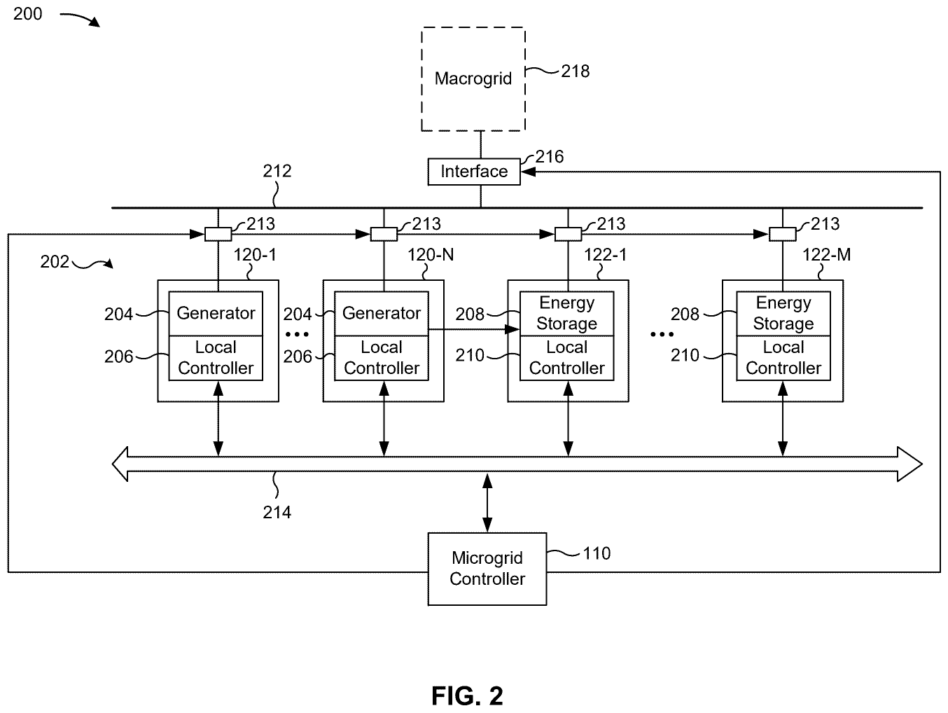

FIG. 2 shows a microgrid 200 according to one or more implementations. The microgrid 200 may be an example of the power system 106 described in connection with FIG. 1. The microgrid 200 may include a plurality of DERs 202. The plurality of DERs 202 may include N energy generator systems 120 and M energy storage systems 122, where N and M are integers greater than zero. For example, the plurality of DERs 202 may include a first energy generator system 120-1 and an Nth energy generator system 120-N. Additionally, the plurality of DERs 202 may include a first energy storage system 122-1 and an M^{th} energy storage system 122-M. Each energy generator system 120 may include a power generator 204 and a local generator controller 206. Each energy storage system 122 may include an electric storage device 208 (e.g., one or more batteries and/or capacitors) and a local ESS controller 210.

Each energy generator system 120 may be coupled to a power bus 212 for providing power to one or more loads connected to the power bus 212. Additionally, each energy storage system 122 may be coupled to the power bus 212 for providing power to or absorbing power from the power bus 212 (e.g., for providing power to or absorbing power from one or more components, such as one or more loads and/or one or more energy generator systems 120 connected to the power bus 212).

The microgrid 200 may also include the microgrid controller 110 that is communicatively coupled to the local controllers (e.g., local generator controllers 206 and local ESS controllers 210) of each DER 202 across a communication bus 214. The communication bus 214 may also enable the microgrid 200 to communicate with one or more loads and/or one or more load management systems (e.g., charging systems, fleet management systems, local load controllers, etc.). In some cases, two or more communication buses 214 may be provided. For example, one communication bus may be provided to communicate with local controllers and another communication bus may be provided to communicate with one or more loads and/or one or more load management systems.

Each local generator controller 206 may include any appropriate hardware, software, and/or firmware to sense and control a respective power generator 204, and send information to, and receive information from microgrid controller 110. For example, a local generator controller 206 may be configured to sense, determine, and/or store generator data of its respective power generator 204. The generator data may be sensed, determined, and/or stored in any conventional manner. Each local generator controller 206 may control whether a respective power generator 204 is connected to or disconnected from the power bus 212 (for example, based on an instruction or a control signal received from the microgrid controller 110).

Each local ESS controller 210 may include any appropriate hardware, software, and/or firmware to sense and control a respective electric storage device 208, and send information to, and receive information from microgrid controller 110. For example, a local ESS controller 210 may be configured to sense, determine, and/or store various characteristics of its respective electric storage device 208. Such characteristics of the respective electric storage device 208 may include, among others, a current SOC, a current energy, an SOC minimum threshold, an SOC maximum threshold, and a discharge limit of the respective electric storage device 208. These characteristics of respective electric storage device 208 may be sensed, determined, and/or stored in any conventional manner. Each local ESS controller 210 may control whether a respective electric storage device 208 is connected to or disconnected from the power bus 212 (for example, based on an instruction or a control signal received from the microgrid controller 110).

The microgrid controller 110 may receive or determine a need for charging or discharging of power from the microgrid 200, and may be configured to determine and send signals to allocate a total charge request and/or total discharge request across all of the plurality of DERs 202.

When performing the power allocation functions, the microgrid controller 110 may allocate a certain amount of power from each energy generator system 120 to one or more loads. When performing the power allocation functions, the microgrid controller 110 may allocate a total charge request and/or a total discharge request across the energy storage systems 122 as a function of a usable energy capacity of each energy storage system 122. The usable energy capacity corresponds to the capacity or amount of energy that an energy storage system 122 can receive in response to a total charging request (usable charge energy), or the capacity or amount of energy that an energy storage system can discharge in response to a total discharge request (usable discharge energy). The usable charge energy is a function of a maximum state of charge, current state of charge, and current energy of the energy storage system, and the usable discharge energy is a function of a minimum state of charge, and current energy of the energy storage system 122. The microgrid controller 110 may determine a usable charge/discharge capacity of each energy storage system 122 (e.g., SOC), a desired charge/discharge of each energy storage system 122, a remainder power of each energy storage system 122, and/or an SOH of each energy storage system 122.

Thus, the microgrid controller 110 regulates a power supply of the microgrid 200 such that an exact amount of desired power flows in or out of the power system 106 at any given time. The microgrid controller 110 may regulate the power supply of the microgrid 200 in cooperation with the local generator controllers 206 and the local ESS controllers 210. The microgrid controller 110 may transmit control signals (e.g., instructions) to the local generator controllers 206 and the local ESS controllers 210 to activate (e.g., to bring online), deactivate (to bring offline), or curtail (limit or regulate to a target output) one or more of the DERs 202. Additionally, or alternatively, the microgrid controller 110 may transmit control signals to one or more switches 213 to control a switch state (e.g., an on state or an off state) of the one or more switches 213, for example, to connect one or more DERs 202 to or disconnect one or more DERs 202 from the microgrid 200 (e.g., the power bus 212). The switches 213 may be integrated in one or both interfaces 116 and 118 described in connection with FIG. 1.

In some cases, two or more power buses 212 may be provided. For example, a power bus may be provided to couple one or more power generators 204 to one or more electric storage devices 208 for charging the one or more electric storage devices 208. For example, the microgrid controller 110 may selectively couple a power generator 204 to an electric storage device 208 to charge the electric storage device 208. Thus, the power bus 212 may be part of a power distribution network of the microgrid 200 that may include one or more power buses used to distribute power between loads and/or DERs 202.

The microgrid 200 may include an interface 216 for connecting the microgrid 200 to and disconnecting the microgrid 200 from an electrical power distribution system 218, such as a macrogrid. The interface 216 may include one or more electrical connections used for connecting the microgrid 200 to the electrical power distribution system 218. The interface 216 may include one or more switches or breakers that are controlled by the microgrid controller 110 for connecting the microgrid 200 to and disconnecting the microgrid 200 from the electrical power distribution system 218. For example, the one or more switches or breakers of the interface 216 may connect the power bus 212 (or another system bus) to or disconnect the power bus 212 (or another system bus) from the electrical power distribution system 218. Thus, the microgrid controller 110 may configure the microgrid 200 to operate in a grid-connected mode by connecting the microgrid 200 to the electrical power distribution system 218 or in a stand-alone mode by disconnecting the microgrid 200 from the electrical power distribution system 218.

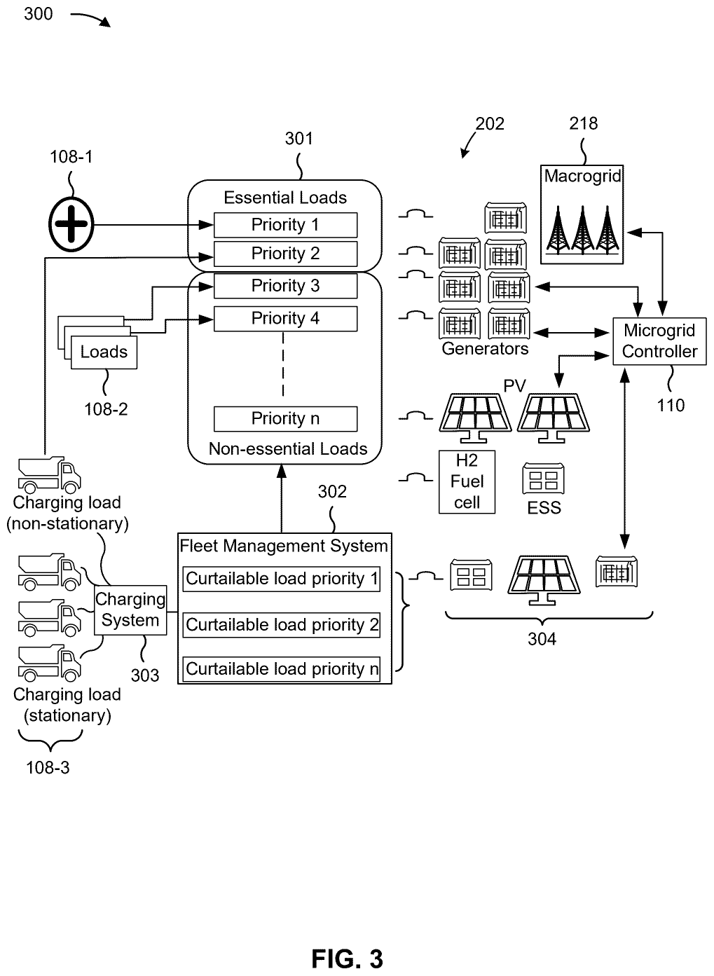

FIG. 3 shows a microgrid 300 according to one or more implementations. The microgrid 300 may be an example of a mine site. The microgrid 300 may be an example of microgrid 200 described in connection with FIG. 2. The microgrid 300 includes the microgrid controller 110 that manages the plurality of DERs 202 (e.g., generator systems, PV cells, fuel cells, ESSs, etc.) and the plurality of loads 108 associated with the microgrid 300. The plurality of loads 108 may include a critical load 108-1 that is assigned a static top priority in a tiered priority scheme 301, non-curtailable loads 108-2, and curtailable loads 108-3. The tiered priority scheme 301 may have a first group of loads (e.g., essential loads) and a second group of loads (e.g., non-essential loads). The microgrid controller 110 may assign each of the plurality of loads 108 a priority level in the tiered priority scheme 301 based on load information corresponding to the plurality of loads 108, as disclosed herein.

The microgrid 300 may include a fleet management system 302 and a charging system 303. The fleet management system 302 may manage a fleet of electric vehicles that represent the curtailable loads 108-3. The fleet management system 302 may collect load information from the curtailable loads 108-3, such as SOC and operating mode, and provide the load information to the microgrid controller 110. The charging system 303 may be coupled to the curtailable loads 108-3 for charging the curtailable loads 108-3. The charging system 303 may regulate power levels provided to the curtailable loads 108-3 and/or charging rates allocated to the curtailable loads 108-3 based on power allocation commands received from the fleet management system 302 or the microgrid controller 110.

The microgrid controller 110 may assign a curtailable load priority to each of the curtailable loads 108-3 and allocate each of the curtailable loads 108-3 to one or more groups, such as the first group of curtailable loads, the second group of curtailable loads, and/or the third group of curtailable loads based on the curtailable load priorities, as disclosed herein. In some cases, the fleet management system 302 may execute the curtailable load algorithm based on an available power limit provided by a subset of DERs 304 that have been allocated by the microgrid controller 110 for use by the charging system 303.

In some implementations, the curtailable load priorities may be incorporated into the tiered priority scheme 301 such that the curtailable loads 108-3 are assigned to the first group of loads (e.g., essential loads) or the second group of loads (e.g., non-essential loads) along with the other loads 108. A curtailable load 108-3 that is in the non-stationary mode may be assigned a higher priority to place that curtailable load 108-3 in the first group of loads (e.g., essential loads) such that the curtailable load 108-3 in the non-stationary mode does not run out of power while navigating an underground mine, which may cause operations within the underground mine to be interrupted.

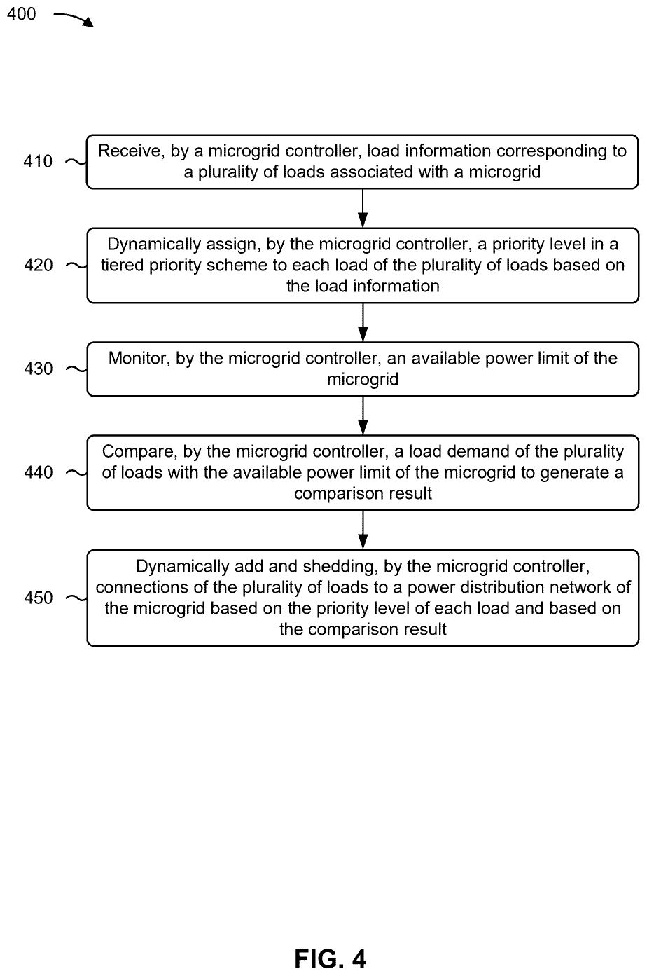

FIG. 4 is a flowchart of an example process 400 associated with essential and curtailable load distribution optimization in a microgrid controller. One or more process blocks of FIG. 4 may be performed by a microgrid controller (e.g., microgrid controller 110). Additionally, or alternatively, one or more process blocks of FIG. 4 may be performed by another device or a group of devices separate from or including the microgrid controller, such as another device or component that is internal or external to a microgrid.

As shown in FIG. 4, process 400 may include receiving load information corresponding to a plurality of loads associated with a microgrid (block 410). For example, the microgrid controller 110 may receive load information corresponding to a plurality of loads associated with a microgrid, as described above.

As further shown in FIG. 4, process 400 may include dynamically assigning a priority level in a tiered priority scheme to each load of the plurality of loads based on the load information (block 420). For example, the microgrid controller 110 may dynamically assign a priority level in a tiered priority scheme to each load of the plurality of loads based on the load information, as described above.

As further shown in FIG. 4, process 400 may include monitoring an available power limit of the microgrid (block 430). For example, the microgrid controller 110 may monitor an available power limit of the microgrid, as described above.

As further shown in FIG. 4, process 400 may include comparing a load demand of the plurality of loads with the available power limit of the microgrid to generate a comparison result (block 440). For example, the microgrid controller 110 may compare a load demand of the plurality of loads with the available power limit of the microgrid to generate a comparison result, as described above.

As further shown in FIG. 4, process 400 may include dynamically adding and shedding connections of the plurality of loads to a power distribution network of the microgrid based on the priority level of each load and based on the comparison result (block 450). Dynamically adding and shedding connections of the plurality of loads to the power distribution network may include generating one or more first control signals to connect a first group of loads having highest rankings in priority level to the power distribution network of the microgrid, and generating one or more second control signals to disconnect a second group of loads having lowest rankings in priority level from the power distribution network of the microgrid. For example, the microgrid controller 110 may dynamically add and shedding connections of the plurality of loads to a power distribution network of the microgrid based on the priority level of each load and based on the comparison result, as described above.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

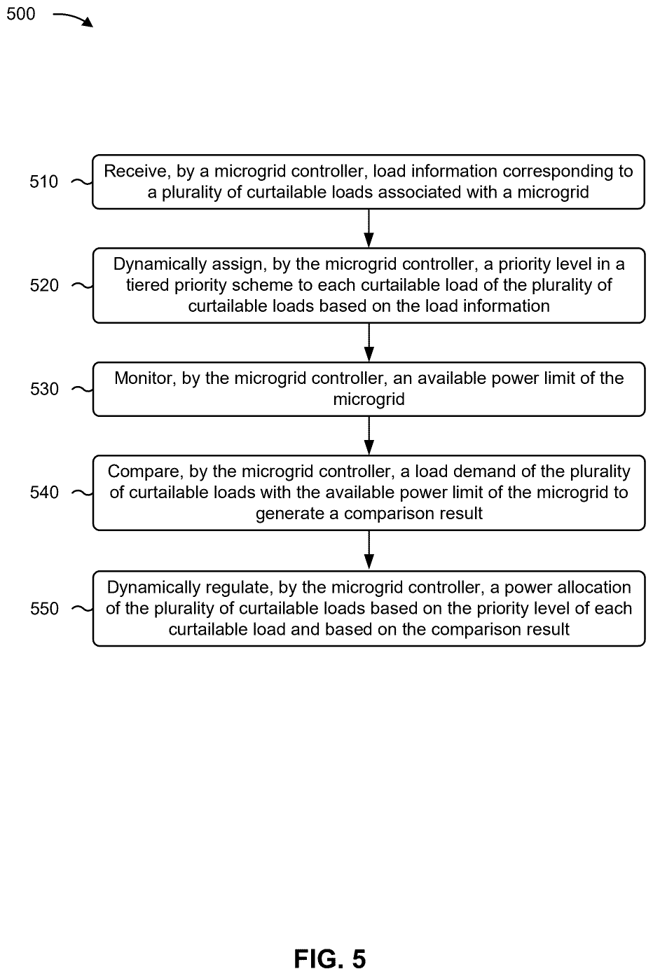

FIG. 5 is a flowchart of an example process 500 associated with essential and curtailable load distribution optimization in microgrid controller. One or more process blocks of FIG. 5 may be performed by a microgrid controller (e.g., microgrid controller 110). Additionally, or alternatively, one or more process blocks of FIG. 5 may be performed by another device or a group of devices separate from or including the microgrid controller, such as another device or component that is internal or external to a microgrid.

As shown in FIG. 5, process 500 may include receiving load information corresponding to a plurality of curtailable loads associated with a microgrid (block 510). For example, the microgrid controller 110 may receive load information corresponding to a plurality of curtailable loads associated with a microgrid, as described above.

As further shown in FIG. 5, process 500 may include dynamically assigning a priority level in a tiered priority scheme to each curtailable load of the plurality of curtailable loads based on the load information (block 520). For example, the microgrid controller 110 may dynamically assign a priority level in a tiered priority scheme to each curtailable load of the plurality of curtailable loads based on the load information, as described above.

As further shown in FIG. 5, process 500 may include monitoring an available power limit of the microgrid (block 530). For example, the microgrid controller 110 may monitor an available power limit of the microgrid, as described above.

As further shown in FIG. 5, process 500 may include comparing a load demand of the plurality of curtailable loads with the available power limit of the microgrid to generate a comparison result (block 540). For example, the microgrid controller may compare a load demand of the plurality of curtailable loads with the available power limit of the microgrid to generate a comparison result, as described above.

As further shown in FIG. 5, process 500 may include dynamically regulating a power allocation of the plurality of curtailable loads based on the priority level of each curtailable load and based on the comparison result (block 550). Dynamically regulating a power allocation of the plurality of curtailable loads may include generating one or more first control signals to allocate one or more prioritized power levels to a first group of curtailable loads having highest rankings in priority level among the plurality of curtailable loads, and generating one or more second control signals to allocate one or more reduced power levels to a second group of curtailable loads having lower rankings in priority level among the plurality of curtailable loads. For example, the microgrid controller 110 may dynamically regulate a power allocation of the plurality of curtailable loads based on the priority level of each curtailable load and based on the comparison result.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

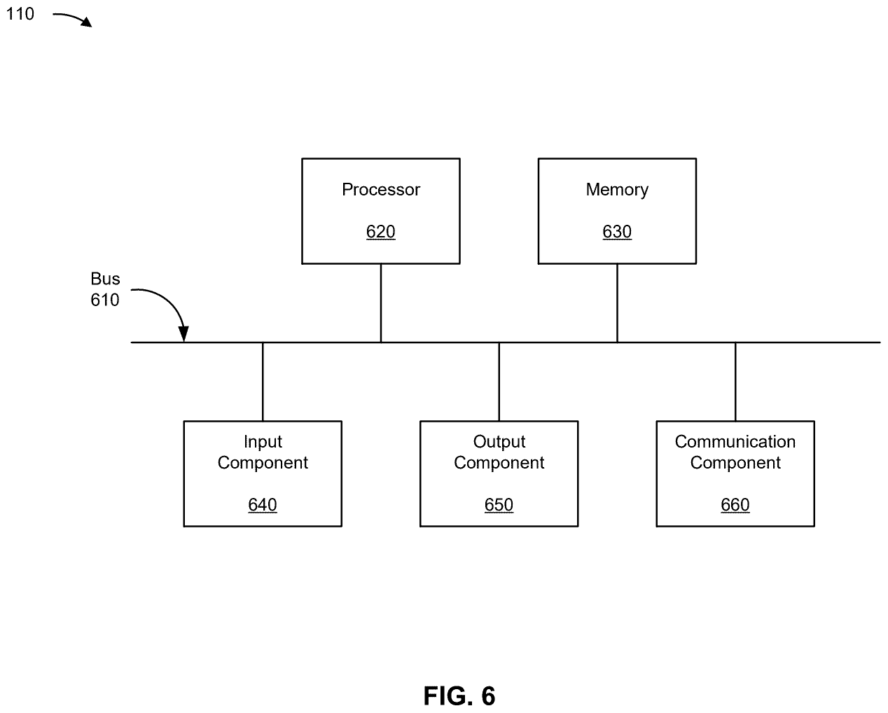

FIG. 6 is a diagram of example components of the microgrid controller 110 associated with improved peak microgrid load dispatch. The microgrid controller 110 may include a bus 610, a processor 620, a memory 630, an input component 640, an output component 650, and/or a communication component 660.

The bus 610 may include one or more components that enable wired and/or wireless communication among the components of the microgrid controller 110. The bus 610 may couple together two or more components of FIG. 6, such as via operative coupling, communicative coupling, electronic coupling, and/or electric coupling. For example, the bus 610 may include an electrical connection (e.g., a wire, a trace, and/or a lead) and/or a wireless bus.

The processor 620 may include a central processing unit a microprocessor, a controller, a microcontroller, a digital signal processor, a field-programmable gate array, an application-specific integrated circuit, and/or another type of processing component. The processor 620 may be implemented in hardware, firmware, or a combination of hardware and software. The processor 620 may include one or more processors capable of being programmed to perform one or more operations or processes described elsewhere herein.

The memory 630 may store information, one or more instructions, and/or software (e.g., one or more software applications) related to the operation of the microgrid controller 110. The memory 630 may include one or more memories that are coupled (e.g., communicatively coupled) to one or more processors (e.g., processor 620), such as via the bus 610. Communicative coupling between a processor 620 and a memory 630 may enable the processor 620 to read and/or process information stored in the memory 630 and/or to store information in the memory 630.

The input component 640 may enable the microgrid controller 110 to receive input, load information, generator data, energy storage data, status information, scheduling information, and/or control signals (e.g., control signals from a macrogrid controller). The output component 650 may enable the microgrid controller 110 to provide output, such as one or more control signals for controlling loads, energy storage systems, breakers, switches, and other components associated with the microgrid described herein. The communication component 660 may enable the microgrid controller 110 to communicate with other devices via a wired connection and/or a wireless connection. For example, the communication component 660 may include a receiver, a transmitter, and/or a transceiver.

The microgrid controller 110 may perform one or more operations or processes described herein. For example, a non-transitory computer-readable medium (e.g., memory 630) may store a set of instructions (e.g., one or more instructions or code) for execution by the processor 620. The processor 620 may execute the set of instructions to perform one or more operations or processes described herein. Execution of the set of instructions, by one or more processors 620, may cause the one or more processors 620 and/or the microgrid controller 110 to perform one or more operations or processes described herein. Hardwired circuitry may be used instead of or in combination with the instructions to perform one or more operations or processes described herein. Additionally, or alternatively, the processor 620 may be configured to perform one or more operations or processes described herein. Thus, implementations described herein are not limited to any specific combination of hardware circuitry and software.

### INDUSTRIAL APPLICABILITY

The disclosed tiered priority scheme may enable a microgrid controller to efficiently manage different types of loads in a power distribution system based on one or more available power limits. A LSLA algorithm enables the microgrid controller prioritize essential loads for uninterrupted service, dynamically manage bidirectional loads, and directly control distribution breakers for flexible load shedding. Activation and deactivation of each load may be based on user-defined conditions, and the LSLA algorithm automatically sheds non-essential loads to maintain power limits for bidirectional loads, ultimately enabling efficient and adaptable power management in diverse scenarios.

What is claimed is:

1. A microgrid controller of a microgrid, comprising:
one or more memories configured to store a load shed/load add (LSLA) algorithm;
a communication interface configured to receive load information corresponding to a plurality of loads and output one or more control signals for controlling connections of the plurality of loads to the microgrid; and
one or more processors, coupled to the one or more memories, configured to execute the LSLA algorithm to generate the one or more control signals based on the load information, wherein executing the LSLA algorithm comprises:
dynamically assigning a priority level in a tiered priority scheme to each load of the plurality of loads based on the load information,
monitoring an available power limit of the microgrid,
comparing a load demand of the plurality of loads with the available power limit of the microgrid to generate a comparison result, and
dynamically adding and shedding the connections of the plurality of loads to a power distribution network of the microgrid based on the priority level of each load and based on the comparison result, including generating one or more first control signals to connect a first group of loads having highest rankings in priority level to the power distribution network of the microgrid, and generating one or more second control signals to disconnect a second group of loads having lowest rankings in priority level from the power distribution network of the microgrid.

2. The microgrid controller of claim 1, wherein the tiered priority scheme is a numeric-based prioritization scheme with the priority level of each load being assigned a different number.

3. The microgrid controller of claim 1, wherein the first group of loads includes a fixed number of essential loads and a variable number of non-essential loads, and
wherein the variable number of non-essential loads depends on the available power limit of the microgrid.

4. The microgrid controller of claim 1, wherein the first group of loads are essential loads, and
wherein the second group of loads are non-essential loads.

5. The microgrid controller of claim 1, wherein the one or more processors are configured to assign a static top priority to an essential load of the plurality of loads.

6. The microgrid controller of claim 1, wherein a first number of loads in the first group of loads and a second number of loads in the second group of loads change based on a change in the available power limit of the microgrid.

7. The microgrid controller of claim 1, wherein the one or more processors are configured to change the priority level of one or more loads based on a change in the load information.

8. The microgrid controller of claim 1, wherein the one or more processors are configured to control open and closed states of a plurality of distribution breakers of the power distribution network in order to control the connections of the plurality of loads to the power distribution network of the microgrid.

9. The microgrid controller of claim 1, wherein the one or more processors are configured to, based on the load information, identify which loads of the plurality of loads are available to receive power from the microgrid as an availability of each load changes, and dynamically assign the priority level to each load of the plurality of loads based on which loads of the plurality of loads are available to receive power from the microgrid.

10. The microgrid controller of claim 9, wherein the one or more processors are configured to change the priority levels of one or more loads based on a load being made available to receive power from the microgrid and based on the load being made unavailable to receive power from the microgrid.

11. The microgrid controller of claim 1, wherein the load information indicates a load type of each load, and
wherein the one or more processors are configured to assign the priority level to each load of the plurality of loads based on the load type of each load.

12. The microgrid controller of claim 1, wherein the load information indicates an operating state of each load, and
wherein the one or more processors are configured to assign the priority level to each load of the plurality of loads based on the operating state of each load.

13. The microgrid controller of claim 1, wherein the plurality of loads includes one or more curtailable loads,
wherein the load information indicates an operating mode of each curtailable load, and
wherein the one or more processors are configured to assign the priority level to each curtailable load based on the operating mode of each curtailable load.

14. The microgrid controller of claim 13, wherein the one or more processors are configured to increase the priority level of a curtailable load based on the curtailable load operating in a first operating mode, and decrease the priority level of the curtailable load based on the curtailable load operating in a second operating mode.

15. The microgrid controller of claim 13, wherein the one or more processors are configured to prioritize a first curtailable load operating in a non-stationary mode over a second curtailable load operating in a stationary mode.

16. The microgrid controller of claim 13, wherein the one or more curtailable loads are charging loads configured with respective chargeable batteries.

17. The microgrid controller of claim 13, wherein the one or more processors are configured to assign each curtailable load in the first group of loads to a first priority sub-group or a second priority sub-group based on the operating mode of each curtailable load in the first group of loads, and
wherein the one or more processors are configured allocate a maximum power level to each curtailable load assigned to the first priority sub-group, and allocate a reduced power level to each curtailable load assigned to the second priority sub-group.

18. A microgrid controller of a microgrid, comprising:
one or more memories configured to store a curtailable load algorithm;
a communication interface configured to receive load information corresponding to a plurality of curtailable loads connected to a microgrid, and output one or more control signals for regulating a power allocation to each of the plurality of curtailable loads; and
one or more processors, coupled to the one or more memories, configured to execute the curtailable load algorithm to generate the one or more control signals based on the load information, wherein executing the curtailable load algorithm comprises:
dynamically assigning a priority level in a tiered priority scheme to each curtailable load of the plurality of curtailable loads based on the load information,
monitoring an available power limit of the microgrid,
comparing a load demand of the plurality of curtailable loads with the available power limit of the microgrid to generate a comparison result, and
dynamically regulating the power allocation of the plurality of curtailable loads based on the priority level of each curtailable load and based on the comparison result, including generating one or more first control signals to allocate one or more prioritized power levels to a first group of curtailable loads having highest rankings in priority level among the plurality of curtailable loads, and generating one or more second control signals to allocate one or more reduced power levels to a second group of curtailable loads having lower rankings in priority level among the plurality of curtailable loads.

19. The microgrid controller of claim 18, wherein the one or more processors are configured to generate one or more third control signals to allocate a zero power level to a third group of curtailable loads having lowest rankings in priority level among the plurality of curtailable loads.

20. A method, comprising:
receiving, by a microgrid controller, load information corresponding to a plurality of loads associated with a microgrid;
dynamically assigning, by the microgrid controller, a priority level in a tiered priority scheme to each load of the plurality of loads based on the load information;
monitoring, by the microgrid controller, an available power limit of the microgrid;
comparing, by the microgrid controller, a load demand of the plurality of loads with the available power limit of the microgrid to generate a comparison result; and
dynamically adding and shedding, by the microgrid controller, connections of the plurality of loads to a power distribution network of the microgrid based on the priority level of each load and based on the comparison result, including generating one or more first control signals to connect a first group of loads having highest rankings in priority level to the power distribution network of the microgrid, and generating one or more second control signals to disconnect a second group of loads having lowest rankings in priority level from the power distribution network of the microgrid.

21. A method, comprising:
receiving, by a microgrid controller, load information corresponding to a plurality of curtailable loads associated with a microgrid;
dynamically assigning, by the microgrid controller, a priority level in a tiered priority scheme to each curtailable load of the plurality of curtailable loads based on the load information;
monitoring, by the microgrid controller, an available power limit of the microgrid;
comparing, by the microgrid controller, a load demand of the plurality of curtailable loads with the available power limit of the microgrid to generate a comparison result; and
dynamically regulating, by the microgrid controller, a power allocation of the plurality of curtailable loads based on the priority level of each curtailable load and based on the comparison result, including generating one or more first control signals to allocate one or more prioritized power levels to a first group of curtailable loads having highest rankings in priority level among the plurality of curtailable loads, and generating one or more second control signals to allocate one or more reduced power levels to a second group of curtailable loads having lower rankings in priority level among the plurality of curtailable loads.
